(19) United States
(12) Patent Application Publication
(10) Pub. No.: US 2006/0220405 A1
(43) Pub. Date: Oct. 5, 2006

(54) Structure for arrangement of engine-associated vehicle components

(75) Inventors: Haruo Ohe, Fuchu-cho (JP); Kouji Iwasaka, Fuchu-cho (JP); Yukio Nakamura, Fuchu-cho (JP)

Correspondence Address: STAAS & HALSEY LLP, SUITE 700, 1201 NEW YORK AVENUE, N.W., WASHINGTON, DC, 20005, US

(73) Assignee: MAZDA MOTOR CORPORATION, Hiroshima (JP)

(21) Appl. No.: 11/363,190

(22) Filed: Feb. 28, 2006

(30) Foreign Application Priority Data
Mar. 31, 2005 (JP) 2005-100523
Mar. 31, 2005 (JP) 2005-100524
Mar. 31, 2005 (JP) 2005-100525

(51) Int. Cl. B60R 7/00

(52) U.S. Cl. 296/37.1

(57) ABSTRACT

A structure for arrangement of engine-associated components including a main battery and a secondary battery which together constitute a power supply system of a vehicle is such that a fresh air duct serving as a fresh air conduit is laid at a forward part of an engine room, an engine body is installed at a rear part of the engine room and fresh air drawn in through the fresh air duct is supplied to the engine body through an intake air passage, wherein the main battery is disposed on one side of the engine body and the secondary battery is disposed on one side of the main battery.

### BACKGROUND OF THE INVENTION

1. Field of the Invention

The present invention relates to a structure for arrangement of engine-associated components, such as a battery constituting a power supply system of a vehicle.

2. Description of the Related Art

There exist conventionally known structures for arrangement of engine-associated vehicle components.

For example, Japanese Unexamined Patent Publication No. 7-228161(1995-228161) describes a structure in which a plurality of cooling fans are arranged in crosswise layers on a rear side of a radiator which is disposed in a forward inclining position at a location corresponding to an external air inlet opening at the front of a vehicle, an engine body is disposed at the back of the cooling fans, and a plurality of engine-associated components, such as an air cleaner and a battery, are mounted one behind another in a space between the cooling fans and the engine body, whereby a cooling air passage for guiding cooling air which has passed through the cooling fans toward the engine body is formed by walls of the plurality of engine-associated components.

Also, Japanese Unexamined Patent Publication No. 2001-63493 describes a structure for arrangement of a vehicle battery in which the battery is supported by a reinforcing beam at a position close to the middle of the crosswise extension thereof via a support base member, the reinforcing beam being mounted between damper bases of suspension devices provided at left and right end portions of an engine room, so that the battery can be located close to the middle of the engine room by using a dead space between an engine and a dashboard while preventing the engine room from becoming unnecessarily large.

If the plurality of engine-associated components, such as the air cleaner and the battery, are arranged along a longitudinal direction of the vehicle body between the cooling fans and the engine body as described in Japanese Unexamined Patent Publication No. 1995-228161, it would be possible to effectively cool the engine body by guiding the cooling air which has passed through the cooling fans to a site where the engine body is mounted in an efficient manner. However, the battery used as a power supply unit of the vehicle has a specific size and weight, so that there can arise a problem with respect to engine room layout if the battery is installed at the front of the engine body. Additionally, if the battery is installed at a frontal part of the vehicle body, it becomes difficult to provide a sufficient crush space which is critical in the event of a collision. Moreover, if the battery is located at a position offset to the left or right of the vehicle body, there can arise a problem that driving stability tends to decrease due to an increase in yaw moment of inertia in maneuvering.

In the aforementioned structure of Japanese Unexamined Patent Publication No. 2001-63493 in which the battery is supported by the reinforcing beam at the position close to the middle of the crosswise extension of the reinforcing beam which is mounted in a rear portion of the engine room to extend in a traverse direction, it would be possible to prevent the increase in the yaw moment of inertia in maneuvering which occurs when the battery is located at a position offset to the left or right of the vehicle body. However, in the structure of this Patent Publication, it is necessary to dispose the engine body at the front of the battery, so that the weight of the vehicle is poorly balanced with the center of gravity of the vehicle body deviating frontward, resulting in a decrease in driving stability. Additionally, this structure would develop a problem that the overall length of an intake air passage for supplying intake air introduced through a fresh air conduit provided at the front of the vehicle to the engine body decreases, causing a deterioration in air intake performance, for instance.

### SUMMARY OF THE INVENTION

In light of the aforementioned problems of the prior art, it is an object of the invention to provide a simple structure for arrangement of engine-associated components of a vehicle capable of providing effectively improved driving stability and air intake performance by using properly designed layout of the engine-associated components.

According to a first principal form of the invention, a structure for arrangement of engine-associated components including a main battery and a secondary battery which together constitute a power supply system of a vehicle is such that a fresh air conduit is laid at a forward part of an engine room, an engine body is installed at a rear part of the engine room and fresh air drawn in through the fresh air conduit is supplied to the engine body through an intake air passage, wherein the main battery is disposed on one side of the engine body and the secondary battery is disposed on one side of the main battery.

In this structure, the engine body is installed at the rear part of the engine room and the main battery and the secondary battery are disposed on one side of the engine body so that it is possible to linearly arrange the intake air passage over a sufficient overall length and thereby improve air intake performance in an efficient manner through effective use of an effect of intake air inertia. Further, as the two batteries are mounted at the back of the engine room, there is created an advantage that it is possible to provide a sufficient crush space which is critical in the event of a collision at the forward part of the engine room and thereby improve the safety of vehicle occupants, for instance.

These and other objects, features and advantages of the invention will become more apparent upon reading the following detailed description along with the accompanying drawings.

### BRIEF DESCRIPTION OF THE DRAWINGS

FIG. 1 is a side view showing a structure for arrangement of engine-associated vehicle components according to a preferred embodiment of the invention;

FIG. 2 is a plan view showing the structure for arrangement of the engine-associated vehicle components according to the preferred embodiment of the invention;

FIG. 3 is a perspective view showing how a main battery and a secondary battery are disposed;

FIG. 4 is a perspective view showing an alternative secondary battery employed in a modified form of the preferred embodiment of FIG. 1;

FIG. 5 is a plan view showing a structure for arrangement of the engine-associated vehicle components according to the modified form of the preferred embodiment of FIG. 1;

FIG. 6 is a side view showing a structure for arrangement of engine-associated vehicle components according to another preferred embodiment of the invention;

FIG. 7 is a perspective view showing how a secondary battery is disposed according to the preferred embodiment of FIG. 6;

FIG. 8 is a side view showing how the secondary battery is disposed in an alternative form of the preferred embodiment of FIG. 6;

FIG. 9 is a plan view showing a structure for arrangement of engine-associated vehicle components according to still another preferred embodiment of the invention;

FIG. 10 is a side view showing the structure for arrangement of the engine-associated vehicle components according to the preferred embodiment of FIG. 9;

FIG. 11 is a perspective view showing how a supporting bracket of the preferred embodiment of FIG. 9 is structured;

FIG. 12 is a perspective view showing how a battery is mounted in the preferred embodiment of FIG. 9;

FIG. 13 is a perspective view showing a specific example of tower bars according to the preferred embodiment of FIG. 9; and

FIG. 14 is a perspective view showing another specific example of tower bars in one modified form of the preferred embodiment of FIG. 9.

### DETAILED DESCRIPTION OF THE PREFERRED EMBODIMENTS OF THE INVENTION

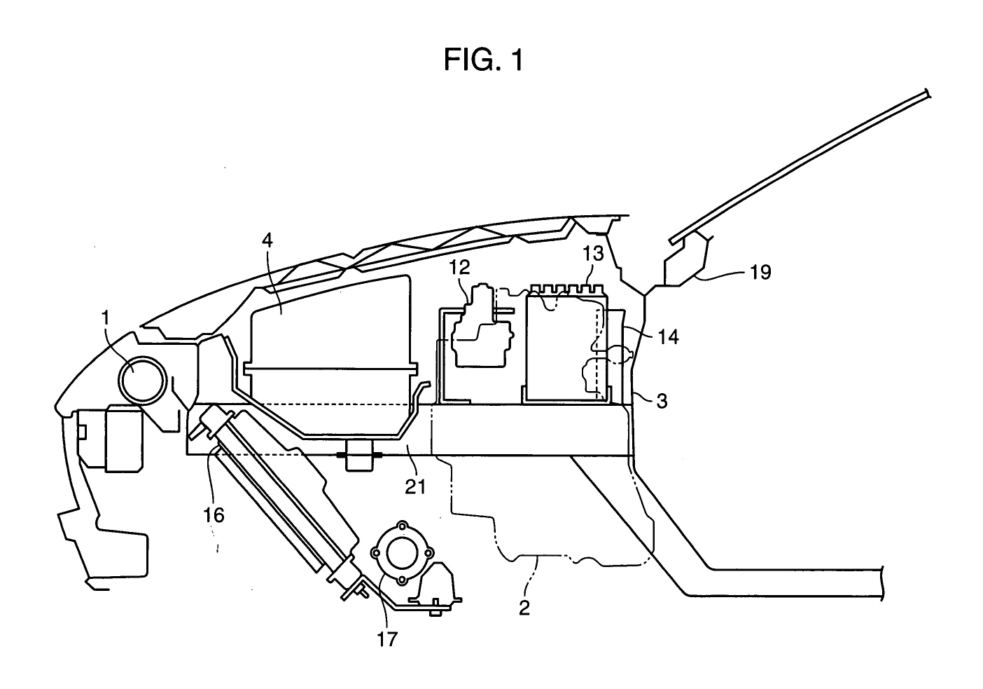

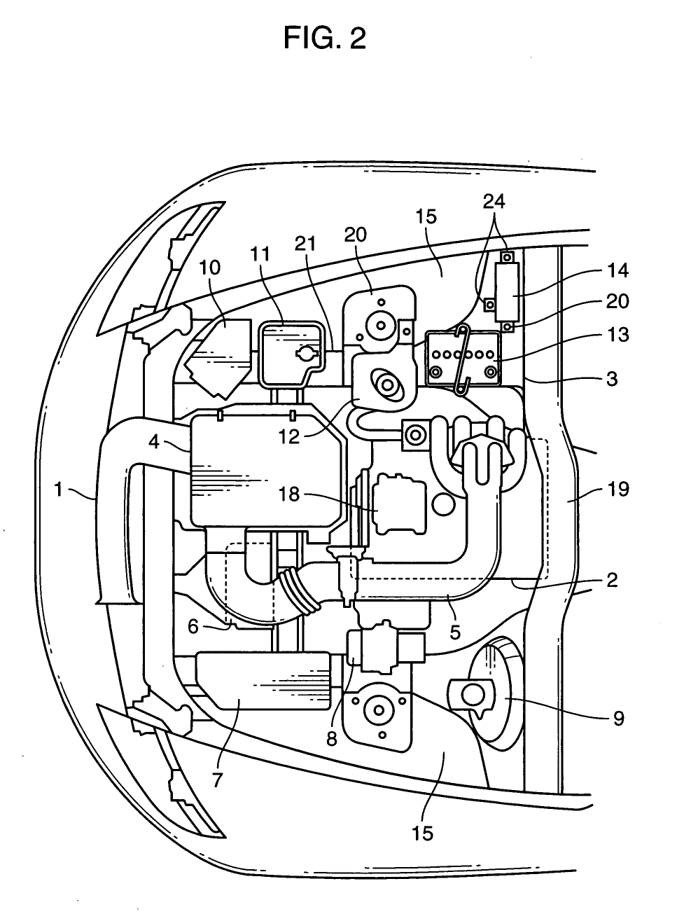

FIGS. 1 and 2 are diagrams showing a structure for arrangement of engine-associated components provided in an engine room of a vehicle according to a preferred embodiment of the invention. As illustrated in these Figures, the engine room accommodates from front to back a fresh air duct 1 serving as a fresh air conduit located at a forward part of the engine room, an air cleaner 4, and an engine body 2 which is a rotary engine located between the air cleaner 4 and a dash panel 3. These components are arranged such that fresh air drawn in through the fresh air duct 1 while the vehicle is running is supplied to the engine body 2 through the air cleaner 4 and an intake air passage 5.

As shown in FIG. 2, there are provided a control unit 6 for a power train and a main fuse box 7 on one side of the air cleaner 4, a hydraulic valve unit 8 for an antilock braking system (ABS) at the rear of the main fuse box 7 on one side of the engine body 2 and a vacuum brake booster (or a so-called master vac) 9 for the braking system mounted on the dash panel 3 traversely extending at the rear of the hydraulic valve unit 8 generally along a left side of the engine room.

On the other hand, there are provided a control unit 10 for a power steering system and a sub-tank 11 on one side of the air cleaner 4 and an air pump 12 for the rotary engine at the rear of the sub-tank 11 generally along a right side of the engine room. Further at the rear of the air pump 12, there are provided a wheel house 15 for a right front wheel on one side of the engine body 2 as well as a main battery 13 and a secondary battery 14 which together constitute a power supply system of the vehicle between the wheel house 15 and a right portion of the dash panel 3.

The main battery 13 is a lead storage battery utilizing a chemical reaction which is widely used as an automotive power supply device. Thus, the main battery 13 is relatively large-sized and has a high changing capacity. In contrast, the secondary battery 14 is a capacitor, such as an electric double-layer capacitor (EDLC), used as an auxiliary power supply device. The secondary battery 14 is small-sized and has a low changing capacity compared to the main battery 13.

Referring to FIG. 1, designated by the reference numeral 16 is a radiator which is disposed in a forward inclining position at a location corresponding to an external air inlet opening at the front of the vehicle, and designated by the reference numeral 17 is a traversely extending steering rack which is disposed at the front of the engine body 2. Referring to FIG. 2, designated by the reference numeral 18 is an alternator which is disposed above the engine body 2, and designated by the reference numeral 19 is a cowling which is disposed above the dash panel 3.

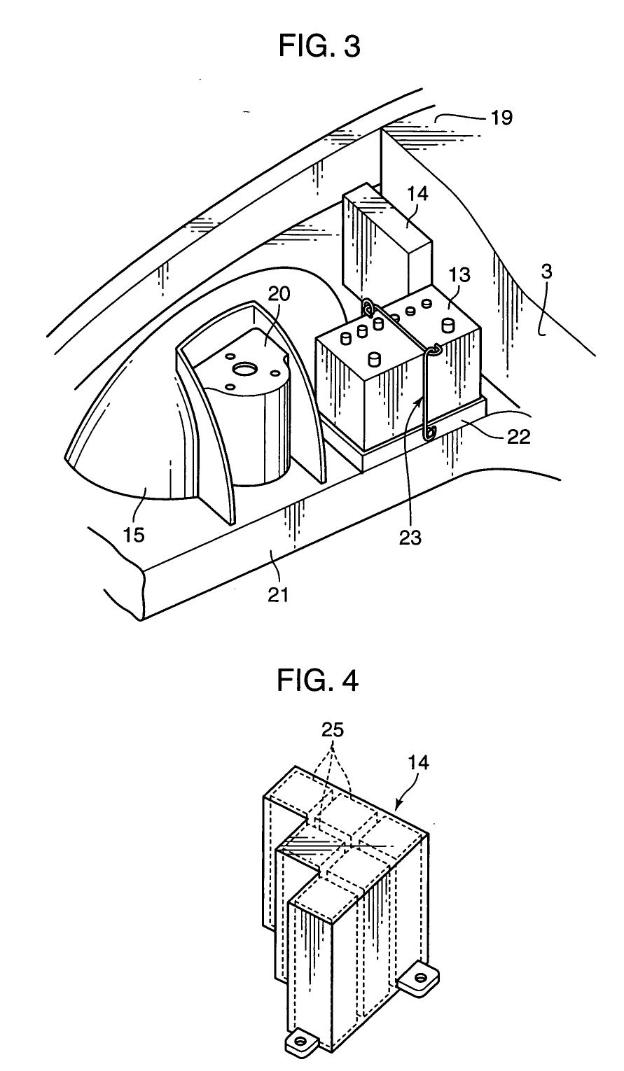

Referring to FIG. 3, the aforementioned main battery 13 is disposed at the rear of a suspension tower 20 erected along a side surface of the right front wheel house 15 and fixed to a battery tray 22 by a battery clamp 23 on the top of a front side frame 21, so that the main battery 13 is mounted along a longitudinal direction of a body of the vehicle in a space bounded by the engine body 2 and the wheel house 15 on left and right sides and by the suspension tower 20 and the dash panel 3 on front and rear sides.

On the other hand, the secondary battery 14 is mounted along a traverse direction of the vehicle body on the outside of the main battery 13 in a space bounded by a rear end of the right front wheel house 15 and the dash panel 3. The secondary battery 14 is bolted to a vehicle body member including the front side frame 21 at fixing flanges 24 extended leftward, frontward and rightward from a bottom end of a battery case as illustrated in FIG. 2.

According to the present embodiment, the vehicle is constructed such that the fresh air duct 1 serving as the fresh air conduit is mounted at the forward part of the engine room, the engine body 2 is installed at a rear part of the engine room, and fresh air drawn in through the fresh air conduit is supplied to the engine body 2 through the intake air passage 5. The engine room accommodates the main battery 13 and the secondary battery 14 which together constitute the power supply system of the vehicle with the main battery 13 disposed on one side of the engine body 2 and the secondary battery 14 disposed on one side of the main battery 13. With the main battery 13 and the secondary battery 14 constituting part of the engine-associated components properly laid out in this fashion, it is possible to effectively improve driving stability and air intake performance with a simple structure.

If the power supply system of the vehicle is configured by the main battery 13 and the secondary battery 14 as discussed above, it is possible to reduce the capacities of the individual batteries 13, 14 compared to a case where the entirety of electric power for operating the engine and onboard equipment is supplied from a single battery. This confers an advantage that the main battery 13 can be disposed in a space bounded by the wheel house 15 for the right front wheel located at one side of the engine room and the traversely extending dash panel 3 mounted at a rear end of the engine room and the secondary battery 14 can be properly disposed in a narrow space formed on the outside of the main battery 13 between the rear end of the right front wheel house 15 and a front side of the dash panel 3.

Also, since the engine body 2 is disposed in a rear portion of the engine room at a position close to the dash panel 3 and the main battery 13 and the secondary battery 14 are mounted on one side of the engine body 2, it is possible to linearly arrange the intake air passage 5 over a sufficient overall length and thereby improve the air intake performance in an efficient manner through effective use of an effect of intake air inertia. Further, as the two batteries 13, 14 are mounted at the back of the engine room, it is possible to provide a sufficient crush space which is critical in the event of a collision at the forward part of the engine room and thereby improve the safety of vehicle occupants. Moreover, both the main battery 13 and the secondary battery 14 can be reduced in weight. This is advantageous in that it is possible to effectively prevent an increase in yaw moment of inertia in maneuvering even when the two batteries 13, 14 are mounted at one side of the engine room.

Especially because the main battery 13 is mounted between the wheel house 15 for the right front wheel located at one side of the engine room and the dash panel 3 mounted at the rear end of the engine room in the foregoing embodiment, there is created an advantage that it is possible to effectively protect an area where the main battery 13 is mounted from an impact load caused by a head-on collision of the vehicle, for instance, and support the main battery 13 in a stable fashion. More specifically, since the right front wheel house 15 is effectively reinforced as the suspension tower 20 having a high degree of stiffness is affixed to the wheel house 15, for instance, it is possible to effectively protect the area where the main battery 13 is mounted from an impact load caused by a head-on collision of the vehicle, for instance, even if an area at the front of the suspension tower 20 is used as part of the crush space. Therefore, it is possible to effectively prevent the occurrence of such a situation that the main battery 13 comes off the battery tray 22 and suffers damage due to an impact load, potentially causing secondary damage to other engine room components.

Also, since the secondary battery 14 is mounted between the wheel house 15 for the right front wheel located at one side of the engine room and the dash panel 3 mounted at the rear end of the engine room in the foregoing embodiment, it is possible to effectively protect an area where the secondary battery 14 is mounted from an impact load caused by a head-on collision of the vehicle, for instance, and support the secondary battery 14 in a stable fashion. Additionally, as the two batteries 13, 14 are arranged close to each other with the secondary battery 14 mounted on one side of the main battery 13, there is created an advantage that it is possible to prevent wirings from the two batteries 13, 14 from becoming too long and simplify wiring work in a case where it is necessary to provide electric power from the two batteries 13, 14 to common onboard components.

While the invention has been described by way of example, with reference to the preferred embodiment employing the main battery 13 which is a lead storage battery having a high changing capacity utilizing a chemical reaction and the secondary battery 14 which is a capacitor, such as an electric double-layer capacitor, having a low changing capacity used as an auxiliary power supply device, the invention is not limited to this structure but may be modified in various ways. For example, the structure of the foregoing embodiment may be modified such that the power supply system of the vehicle includes the main battery 13 which is a lead storage battery and the secondary battery 14 which is a lead storage battery smaller than the main battery 13, the secondary battery 14 being mounted between the wheel house 15 for the right front wheel located at one side of the engine room and the dash panel 3 mounted at the rear end of the engine room.

Alternatively, the secondary battery 14 may be a lithium ion battery which is a secondary battery which accumulates and releases electrical charge through exchange of lithium ions between a positive electrode and a negative electrode. Although the lithium ion battery is expensive, it has such advantages as superior durability and high energy density (i.e., the amount of electric energy that the battery can retain per unit weight), so that the power supply system can be made compact and properly laid out with each in a limited space of the engine room.

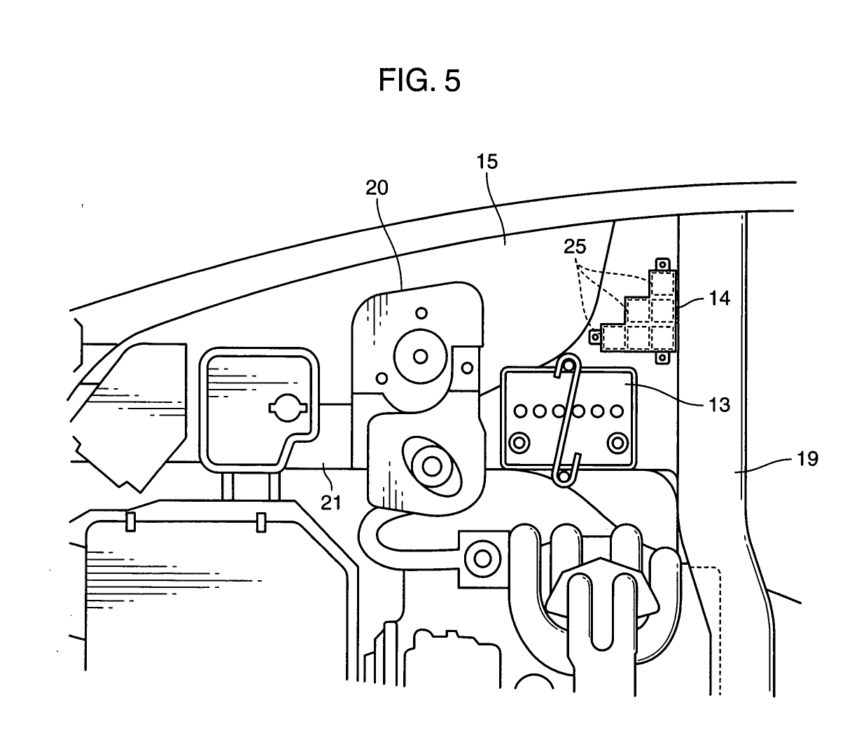

In addition, since the lithium ion battery is made of a plurality of series-connected unit cells 25; the secondary battery 14 can be arranged such that a larger number of unit cells 25 are disposed on a side facing the center line of the vehicle body and a smaller number of unit cells 25 are disposed on the opposite side as illustrated in FIGS. 4 and 5. This arrangement confers an advantage that the lithium ion battery constituting the secondary battery 14 can be disposed in an efficient manner by effectively using the narrow space formed between the rear end of the right front wheel house 15 and the dash panel 3.

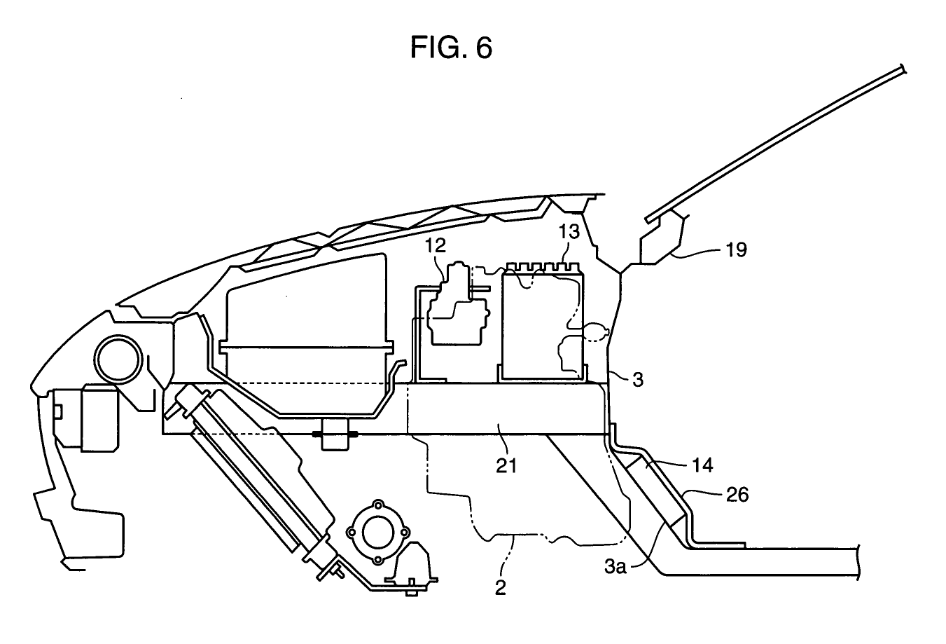

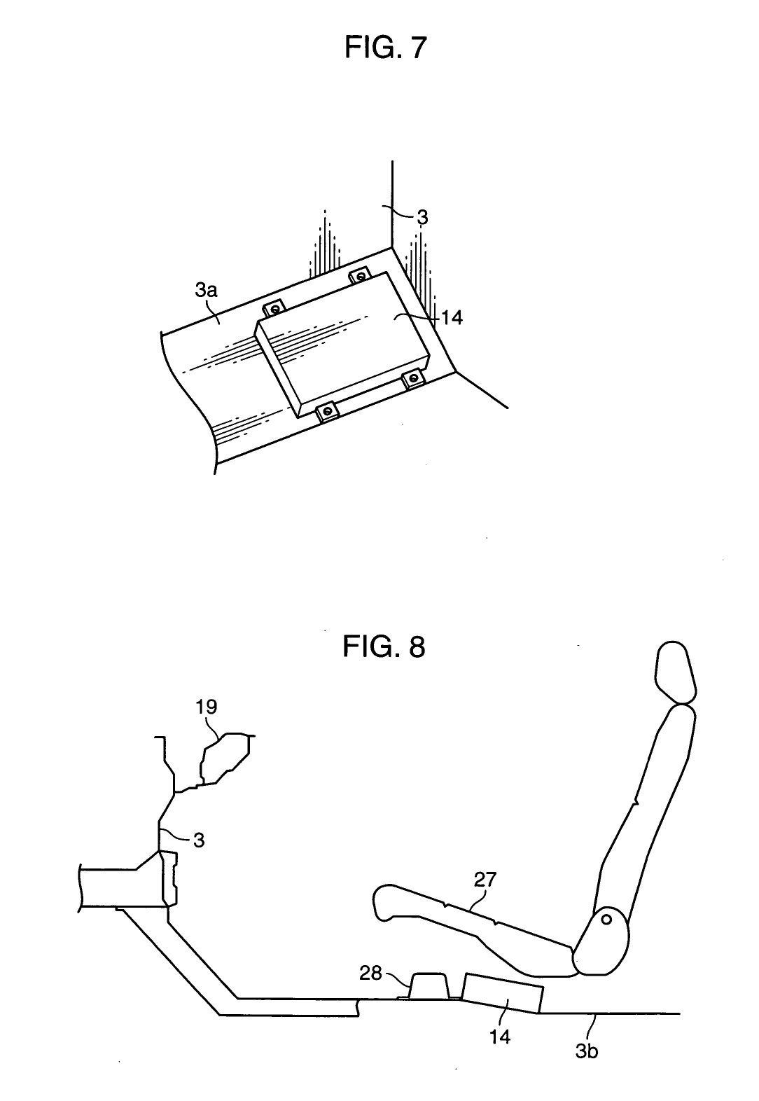

According to another preferred embodiment of the invention, a structure for arrangement of engine-associated components provided in an engine room of a vehicle is such that the fresh air duct 1 serving as the fresh air conduit is mounted at the forward part of the engine room, the engine body 2 is installed at the rear part of the engine room, the main battery 13 is disposed on one side of the engine body 2 and the secondary battery 14 is disposed in a passenger compartment, the main battery 13 and the secondary battery 14 together constituting a power supply system of the vehicle. For example, the secondary battery 14 may be mounted on a slant surface 3a rising obliquely frontward below the dash panel 3 which is disposed at the rear end of the engine room and an area where the secondary battery 14 is located is covered by a floor mat 26 as shown in FIGS. 6 and 7. Alternatively, the secondary battery 14 may be mounted on a floor panel 3b at a position immediately behind a cross member 28 traversely extending underneath a seat cushion 27 of an occupant's seat installed in the passenger compartment as shown in FIG. 8.

If the engine body 2 is disposed in a rear portion of the engine room and the secondary battery 14 is mounted in the passenger compartment by effectively using a dead space therein as described above, it is possible to linearly arrange the intake air passage 5 over a sufficient overall length and thereby improve the air intake performance in an efficient manner and reduce the size of the engine room.

Especially when the secondary battery 14 is mounted below the dash panel 3, or on the slant surface 3a, as shown in FIGS. 6 and 7, it is possible to prevent the main battery 13 and the secondary battery 14 from being separated too much from each other. This produces an advantage that it is possible to shorten wirings from the two batteries 13, 14 and simplify wiring work in a case where it is necessary to provide electric power from the two batteries 13, 14 to common onboard components.

On the other hand, if the secondary battery 14 is mounted below the seat cushion 27 of the occupant's seat in the passenger compartment as shown in FIG. 8, the power supply system of the vehicle may be configured such that the main battery 13 supplies electric power to individual electrical components in the engine room and the secondary battery 14 supplies electric power to individual electrical components in the passenger compartment, for instance. This arrangement confers an advantage that wiring and power supply efficiencies can be effectively improved.

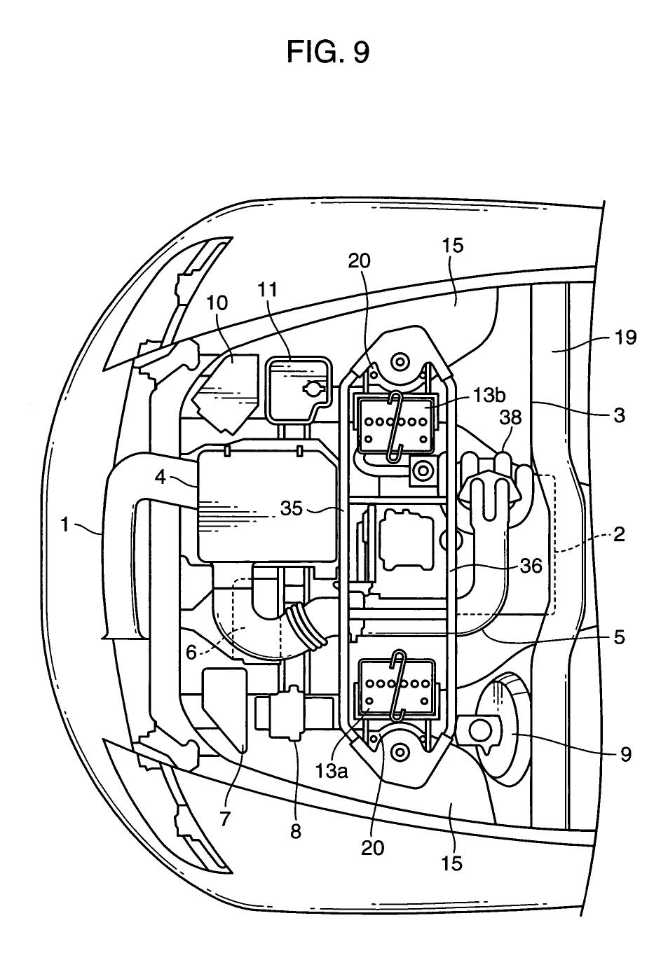

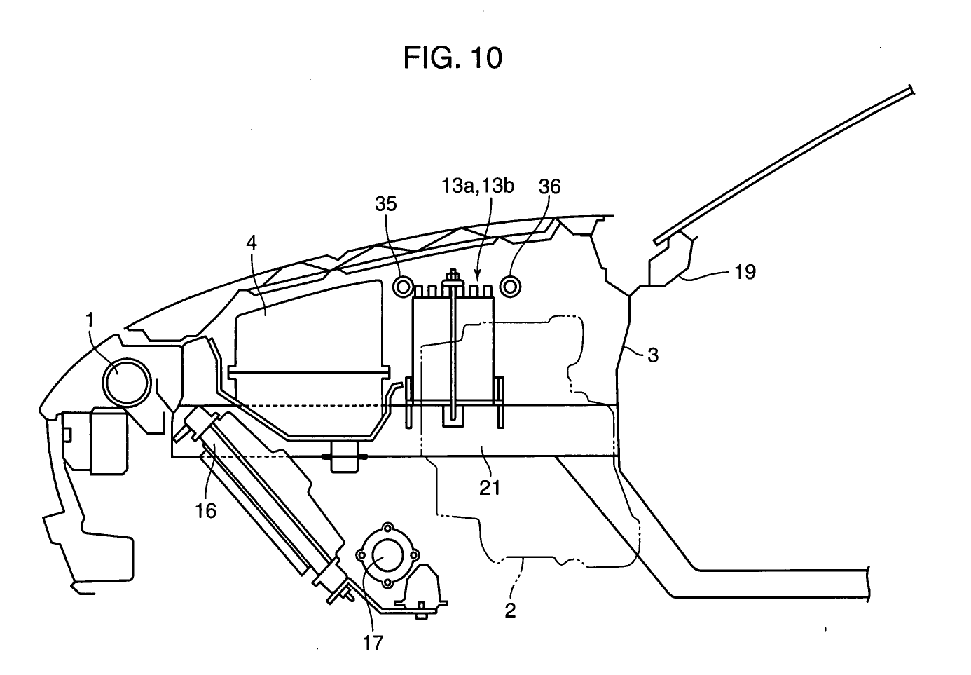

According to still another preferred embodiment of the invention, a structure for arrangement of engine-associated components provided in an engine room of a vehicle is such that a first battery 13a and a second battery 13b which are disposed at left and right sides of the engine room as illustrated in FIGS. 9 and 10. One of the first and second batteries 13a, 13b is a lead storage battery utilizing a chemical reaction which is widely used as an automotive power supply device and the other is a capacitor, such as an electric double-layer capacitor, used as an auxiliary power supply device or a lithium ion battery which is a secondary battery which accumulates and releases electrical charge through exchange of lithium ions between a positive electrode and a negative electrode, for example.

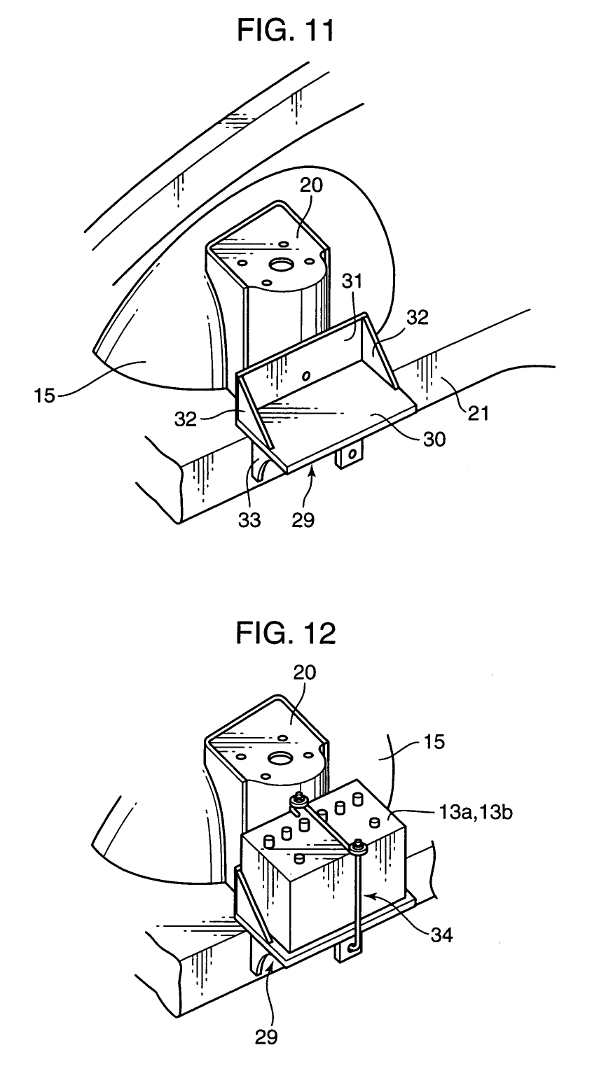

The capacities of the first and second batteries 13a, 13b are determined such that the two batteries 13a, 13b have approximately the same weight. The first and second batteries 13a, 13b are disposed symmetrically crosswise in areas surrounded by left and right front wheel houses 15 and the engine body 2. More specifically, a pair of suspension towers 20 is erected along side surfaces of the wheel houses 15 covering left and right front wheels and the batteries 13a, 13b are sustained by supporting brackets 29 affixed to basal parts of the suspension towers 20 as illustrated in FIGS. 11 and 12. With this arrangement, the two batteries 13a, 13b are symmetrically disposed on both sides of the engine body 2 which is installed generally at the middle of the vehicle width in a rear portion of the engine room.

Each of the supporting brackets 29 includes a bottom plate 30 affixed to the top of the front side frame 21 so that the bottom plate 30 projects inward from the basal part (lower end) of the suspension tower 20 erected on the vehicle body, a rectangular side plate 31 affixed to the top of the bottom plate 30 along an outer end thereof, upward-narrowing front and rear upper gusset plates 32 affixed to the top of the bottom plate 30 along front and rear ends thereof, and downward-narrowing front and rear lower gusset plates 33 affixed to the bottom of the bottom plate 30 along the front and rear ends thereof. The first and second batteries 13a, 13b sustained by the left and right supporting brackets 29 are fixed thereto by respective battery clamps 34.

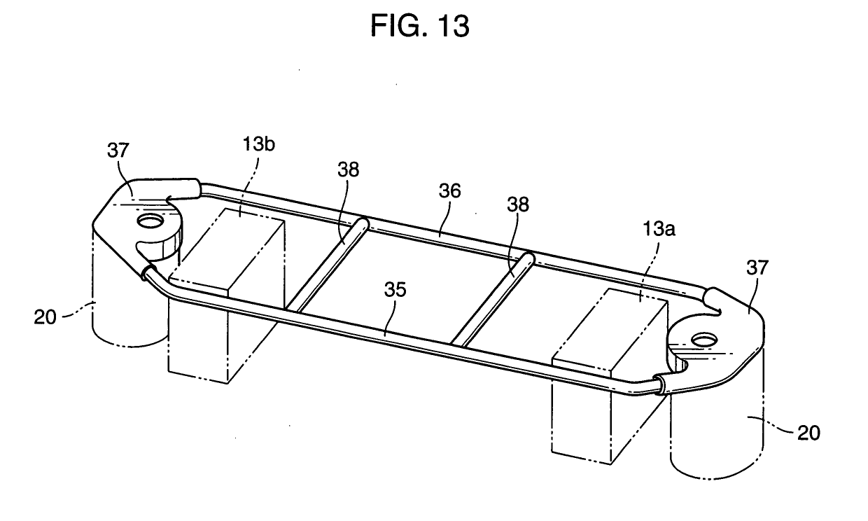

Referring to FIG. 13, upper ends of the left and right suspension towers 20 are interconnected by a pair of front and rear tower bars 35, 36 which are made of steel or aluminum pipes, for instance, arranged at a specific distance from each other in the longitudinal direction of the vehicle body. These tower bars 35, 36 serve to prevent the suspension towers 20 from tipping over inward, for instance. Left and right ends of the two tower bars 35, 36 are fixed to the upper ends of the suspension towers 20 by a pair of mounting brackets 37 as illustrated. The front tower bar 35 extends crosswise at the front of the two batteries 13a, 13b while the rear tower bar 36 extends crosswise at the rear of the two batteries 13a, 13b so that the first and second batteries 13a, 13b are located between the front and rear tower bars 35, 36. The front and rear tower bars 35, 36 are joined to each other by a pair of left and right connecting members 38 which are made of steel or aluminum pipes, for instance, located on the inside of areas where the first and second batteries 13a, 13b are mounted.

According to the present embodiment, the vehicle is constructed such that the fresh air duct 1 serving as the fresh air conduit is mounted at the forward part of the engine room, the engine body 2 is installed at the rear part of the engine room, and fresh air drawn in through the fresh air conduit is supplied to the engine body 2 through the intake air passage 5. The engine room accommodates the first and second batteries 13a, 13b which together constitute a power supply system of the vehicle with the two batteries 13a, 13b disposed on left and right sides of the engine body 2. With the first and second batteries 13a, 13b constituting part of the engine-associated components properly laid out in this fashion, it is possible to effectively improve driving stability and air intake performance with a simple structure.

If the power supply system of the vehicle is configured by the multiple batteries 13a, 13b as discussed above, it is possible to reduce the capacities of the individual batteries 13a, 13b compared to a case where the entirety of electric power for operating the engine and onboard equipment is supplied from a single battery. This confers an advantage that both of the batteries 13a, 13b can be properly disposed in narrow spaces formed at opposite sides of the engine room. Additionally, as the two batteries 13a, 13b are disposed at the left and right sides of the engine room, the weight of the vehicle is properly balanced along the traverse direction of the vehicle body. This makes it possible to prevent an increase in yaw moment of inertia in maneuvering and effectively improve driving stability.

Furthermore, unlike a case where the batteries are installed at the rear of the engine body 2, the above-described structure of the present embodiment makes it possible to locate the engine body 2 in a rear portion of the engine room at a position close to the dash panel 3 and not at a forward part of the vehicle body. This makes it possible to arrange the intake air passage 5 over a sufficient overall length and thereby improve the air intake performance in an efficient manner through effective use of the effect of intake air inertia. Also, as the first and second batteries 13a, 13b are mounted on the left and right sides of the engine body 2 at the back of the engine room, it is possible to provide a sufficient crush space which is critical in the event of a collision at the forward part of the engine room and thereby improve the safety of vehicle occupants.

Especially when the two batteries 13a, 13b are symmetrically disposed on both sides of the engine body 2 as discussed in the foregoing embodiment, it is possible to properly balance the weight of the vehicle along the traverse direction of the vehicle body. This is advantageous in that the driving stability of the vehicle can be further improved in an effective fashion.

Also, since the two batteries 13a, 13b are mounted in the areas surrounded by the left and right front wheel houses 15 which are disposed at the left and right sides of the engine room and the engine body 2, portions of the vehicle body where the front wheel houses 15 are provided can effectively sustain an impact load caused by a head-on collision of the vehicle, for instance. Therefore, the structure of the present embodiment can effectively protect the areas where the first and second batteries 13a, 13b are mounted from the impact load and thereby support the individual batteries 13a, 13b in a stable fashion. Also, the structure of the embodiment confers an advantage that areas of the engine room at the front of the front wheel houses 15 can be effectively used as part of the crush space which is critical in the event of a collision.

More specifically, since the front wheel houses 15 are effectively reinforced as the suspension towers 20 having a high degree of stiffness are affixed to the wheel houses 15, for instance, it is possible to effectively protect the areas where the first and second batteries 13a, 13b are mounted from an impact load caused by a head-on collision of the vehicle, for instance, and support the batteries 13a, 13b in a stable fashion even if the areas of the engine room at the front of the front wheel houses 15 are used as part of the crush space. This structure is advantageous for preventing the occurrence of such a situation that the batteries 13a, 13b come off the supporting brackets 29 and suffer damage due to an impact load caused by a head-on collision of the vehicle, for instance, potentially causing secondary damage to other engine room components.

Also, when the supporting brackets 29 are affixed to the suspension towers 20 which are erected along the front wheel houses 15 and the two batteries 13a, 13b are sustained by the supporting brackets 29 as discussed above, it is possible to effectively reinforce portions of the vehicle body where the suspension towers 20 are erected by the supporting brackets 29 and thereby improve the stiffness of the portions of the vehicle body where the suspension towers 20 are provided. Furthermore, a sufficient degree of stiffness is given to the supporting brackets 29 by the suspension towers 20. This is advantageous in that the individual batteries 13a, 13b can be supported with sufficient strength.

Especially when each of the supporting brackets 29 is made up of the bottom plate 30 affixed along the suspension tower 20, the rectangular side plate 31 affixed to the bottom plate 30 along the outer end thereof, and the upper and lower gusset plates 32, 33 affixed to the bottom plate 30 along the front and rear ends thereof as discussed in the foregoing embodiment, it is possible to effectively reinforce the portions of the vehicle body where the suspension towers 20 are erected by the supporting brackets 29. This confers an advantage that it is possible to sufficiently improve the stiffness of areas where the supporting brackets 29 are mounted and more effectively protect the areas where the first and second batteries 13a, 13b are mounted from an impact load caused by a head-on collision of the vehicle, for instance, so that the batteries 13a, 13b can be supported in a stable fashion.

Furthermore, the intake air passage 5 for supplying fresh air drawn in through the fresh air duct 1 into the air cleaner 4 to the engine body 2 is arranged to extend along the longitudinal direction of the vehicle body such that the intake air passage 5 passes between the two batteries 13a, 13b which are disposed on the left and right sides of the engine body 2 in the foregoing embodiment. This makes it possible to arrange the intake air passage 5 over a sufficient overall length, for instance, and thereby improve air intake efficiency through effective use of the effect of intake air inertia.

More specifically, a downstream portion of the intake air passage 5 projecting sideways from a side surface of the air cleaner 4 is laid rearward through a space formed between the second battery 13b disposed at the left side of the engine room and the engine body 2 and connected to an intake manifold 39 which is positioned on an upper rear surface of the engine body 2 in the present embodiment as illustrated in FIG. 9. This arrangement makes it possible to run the intake air passage 5 over a sufficient overall length while preventing the intake air passage 5 from being bent in a complicated shape. Accordingly, it is possible to improve intake air charging efficiency by taking full advantage of an effect of dynamic behavior of the intake air supplied to the engine body 2 according to the structure of the embodiment.

Additionally, when one of the first and second batteries 13a, 13b is a lead storage battery and the other is a capacitor for providing auxiliary power as in the foregoing embodiment, there is created an advantage that it is possible to properly supply electric power to individual electrical components of the vehicle by the first battery 13a or the second battery 13b as appropriate according to running conditions of the vehicle or charging conditions of the capacitor, for instance. If a lead storage battery characterized by its ability to supply electric power for an extended period of time is used as the first battery 13a and a capacitor characterized by its quick charging capability is used as the second battery 13b, for example, it possible to reduce power consumption of the first battery 13a by using the second battery 13b under normal running conditions of the vehicle or immediately after stop, for instance, when the second battery 13b is sufficiently charged. On the other hand, this arrangement is advantageous in that electric power can be properly supplied to the individual electrical components of the vehicle by using the first battery (lead storage battery) 13a when output voltage of the second battery (capacitor) 13b has dropped.

In the above-described preferred embodiment, the front and rear tower bars 35, 36 interconnecting the left and right suspension towers 20 disposed at the left and right sides of the engine room are arranged at a specific distance from each other in the longitudinal direction of the vehicle body, and the first and second batteries 13a, 13b together constituting the power supply system of the vehicle are located between the front and rear tower bars 35, 36. This structure of the preferred embodiment is advantageous in that the tower bars 35, 36 serve to effectively prevent the suspension towers 20 from tipping over inward and sufficiently improve the stiffness of the vehicle body, and the first and second batteries 13a, 13b can be arranged by effectively using a space formed between the front and rear tower bars 35, 36 and supported in a stable fashion.

Especially when the two batteries 13a, 13b are symmetrically disposed on both sides of the engine body 2 between the front and rear tower bars 35, 36 interconnecting the left and right suspension towers 20 as discussed in the foregoing embodiment, it is possible to properly balance the weight of the vehicle along the traverse direction of the vehicle body while effectively preventing the suspension towers 20 from tipping over inward by the tower bars 35, 36. This is advantageous in that the driving stability of the vehicle can be further improved in an effective fashion.

Also, when the front and rear tower bars 35, 36 are joined to each other by the connecting members 38 as discussed in the foregoing embodiment, the connecting members 38 serve to reinforce the tower bars 35, 36 and increase the stiffness thereof. This is advantageous in that the tower bars 35, 36 can prevent the suspension towers 20 from tipping over inward and protect the areas where the first and second batteries 13a, 13b are mounted from an impact load caused by a head-on collision of the vehicle, for instance, in a more effective fashion.

While the supporting brackets 29 are affixed to the left and right suspension towers 20 and the two batteries 13a, 13b are mounted on those supporting brackets 29 in the above-described preferred embodiment, this structure of the preferred embodiment may be modified such that the first and second batteries 13a, 13b are mounted on supporting brackets fixed to the two tower bars 35, 36 which are provided for preventing the suspension towers 20 from tipping over inward, for instance.

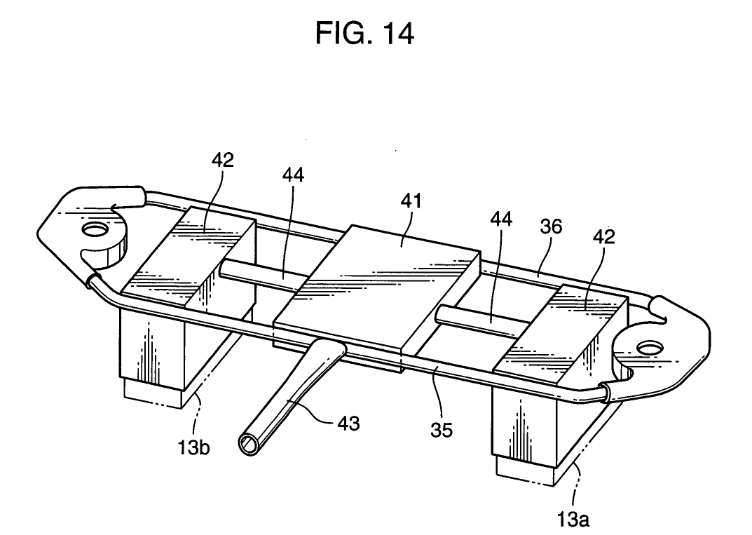

The above-described structure of the preferred embodiment illustrated in FIG. 13 may be modified such that an air guide for guiding fresh air introduced through an opening formed in a front bumper or in a hood, for instance, to the areas where the first and second batteries 13a, 13b are mounted is provided between the front and rear tower bars 35, 36. For example, the air guide provided between the front and rear tower bars 35, 36 includes an air box 41 serving as a connecting member having a closed cross section disposed between the two tower bars 35, 36 which are provided for preventing the suspension towers 20 from tipping over inward, for instance, and a pair of air guide pipes 44 extending to both sides from the air box 41 to connect the air box 41 to left and right battery covers 42 covering the first and second batteries 13a, 13b as shown in FIG. 14.

According to this modified form of the preferred embodiment, it is possible to guide the fresh air introduced into the air box 41 through an air pipe 43 into the battery covers 42 and thereby cool the individual batteries 13a, 13b. This structure is advantageous in that it becomes possible to effectively prevent deterioration of the batteries 13a, 13b due to an excessive temperature increase thereof as well as deterioration of charging performance thereof. Moreover, since the connecting member made of the air box 41 serves to effectively reinforce the tower bars 35, 36 and increase the stiffness thereof, it is possible to effectively prevent the suspension towers 20 from tipping over inward.

Furthermore, when the plurality of batteries 13a, 13b are disposed between the front and rear tower bars 35, 36 interconnecting the left and right suspension towers 20 and the intake air passage 5 for supplying fresh air drawn in through the fresh air duct 1 into the air cleaner 4 to the engine body 2 is arranged to extend along the longitudinal direction of the vehicle body passing between the two batteries 13a, 13b which are disposed on the left and right sides of the engine body 2 as discussed in the foregoing embodiment, there is created an advantage that it is possible to arrange the intake air passage 5 over a sufficient overall length, for instance, and thereby improve the air intake efficiency through effective use of the effect of intake air inertia while effectively preventing the suspension towers 20 from tipping over inward by the tower bars 35, 36.

In summary, according to a first principal form of the invention, a structure for arrangement of engine-associated components including a main battery and a secondary battery which together constitute a power supply system of a vehicle is such that a fresh air conduit is laid at a forward part of an engine room, an engine body is installed at a rear part of the engine room and fresh air drawn in through the fresh air conduit is supplied to the engine body through an intake air passage, wherein the main battery is disposed on one side of the engine body and the secondary battery is disposed on one side of the main battery.

In this structure, the engine body is installed at the rear part of the engine room and the main battery and the secondary battery are disposed on one side of the engine body so that it is possible to linearly arrange the intake air passage over a sufficient overall length and thereby improve air intake performance in an efficient manner through effective use of an effect of intake air inertia. Further, as the two batteries are mounted at the back of the engine room, there is created an advantage that it is possible to provide a sufficient crush space which is critical in the event of a collision at the forward part of the engine room and thereby improve the safety of vehicle occupants, for instance.

In one feature of the invention, the structure for arrangement of the engine-associated components of the aforementioned first principal form is such that the main battery is disposed between a wheel house for one of front wheels located at one side of the engine room and a traversely extending dash panel mounted at a rear end of the engine room.

In this structure, the main battery is disposed between the wheel house for one of the front wheels located at one side of the engine room and the dash panel mounted at the rear end of the engine room, so that there is created an advantage that it is possible to effectively protect an area where the main battery is mounted from an impact load caused by a head-on collision of the vehicle, for instance, and support the main battery in a stable fashion.

In another feature of the invention, the structure for arrangement of the engine-associated components of the aforementioned first principal form is such that the secondary battery is disposed between a wheel house for one of front wheels located at one side of the engine room and a traversely extending dash panel mounted at a rear end of the engine room.

In this structure, the secondary battery is disposed between the wheel house for one of the front wheels located at one side of the engine room and the dash panel mounted at the rear end of the engine room, so that it is possible to effectively protect an area where the secondary battery is mounted from an impact load caused by a head-on collision of the vehicle, for example, and support the secondary battery in a stable fashion. Additionally, as the two batteries are arranged close to each other with the secondary battery mounted on one side of the main battery, there is created an advantage that it is possible to prevent wirings from the two batteries from becoming too long and simplify wiring work in a case where it is necessary to provide electric power from the two batteries to common onboard components.

According to a second principal form of the invention, a structure for arrangement of engine-associated components including a main battery and a secondary battery which together constitute a power supply system of a vehicle is such that a fresh air conduit is laid at a forward part of an engine room and an engine body is installed at a rear part of the engine room, wherein the main battery is disposed on one side of the engine body and the secondary battery is disposed in a passenger compartment of the vehicle.

In this structure, the engine body is installed at the rear part of the engine room and the secondary battery is mounted in the passenger compartment by effectively using a dead space therein, so that it is possible to linearly arrange the intake air passage over a sufficient overall length and thereby improve the air intake performance in an efficient manner and reduce the size of the engine room.

In one feature of the invention, the structure for arrangement of the engine-associated components of the aforementioned second principal form is such that the secondary battery is disposed below a traversely extending dash panel mounted at a rear end of the engine room.

In this structure, the secondary battery is disposed below the dash panel mounted at the rear end of the engine room, so that it is possible to prevent the main battery and the secondary battery from being separated too much from each other. This produces an advantage that it is possible to shorten wirings from the two batteries and simplify wiring work in a case where it is necessary to provide electric power from the two batteries to common onboard components.

In another feature of the invention, the structure for arrangement of the engine-associated components of the aforementioned second principal form is such that the secondary battery is disposed underneath a seat cushion of an occupant seat installed in the passenger compartment.

In this structure, the secondary battery is disposed underneath the seat cushion of the occupant seat installed in the passenger compartment, so that the power supply system of the vehicle can be configured such that the main battery supplies electric power to individual electrical components in the engine room and the secondary battery supplies electric power to individual electrical components in the passenger compartment. This arrangement confers an advantage that wiring and power supply efficiencies can be effectively improved.

According to a third principal form of the invention, a structure for arrangement of engine-associated components including at least two batteries which together constitute a power supply system of a vehicle is such that a fresh air conduit is laid at a forward part of an engine room, an engine body is installed at a rear part of the engine room and fresh air drawn in through the fresh air conduit is supplied to the engine body through an intake air passage, wherein the aforementioned at least two batteries are disposed on left and right sides of the engine body.

In this structure, the engine body is installed at the rear part of the engine room and the aforementioned at least two batteries are disposed on the left and right sides of the engine body, so that it is possible to reduce the capacities of the individual batteries which together constitute the power supply system of the vehicle and arrange the batteries with improved layout. The structure also makes it possible to provide a sufficient crush space which is critical in the event of a collision at the front of the batteries and thereby improve the safety of vehicle occupants. Also, as the batteries are disposed on the left and right sides of the engine body, there is created an advantage that it possible to prevent an increase in yaw moment of inertia in maneuvering in an effective fashion.

In one feature of the invention, the structure for arrangement of the engine-associated components of the aforementioned third principal form is such that the aforementioned at least two batteries are symmetrically disposed on both sides of the engine body.

In this structure, the aforementioned at least two batteries are symmetrically disposed on both sides of the engine body, so that it is possible to properly balance the weight of the vehicle along the traverse direction of the vehicle body. This is advantageous in that the driving stability of the vehicle can be further improved in an effective fashion.

In another feature of the invention, the structure for arrangement of the engine-associated components of the aforementioned third principal form is such that the aforementioned at least two batteries are disposed in areas surrounded by wheel houses for front wheels located at left and right sides of the engine room and the engine body.

In this structure, the aforementioned at least two batteries are disposed in the areas surrounded by the wheel houses for the front wheels located at the left and right sides of the engine room and the engine body, so that it is possible to effectively protect the areas where the batteries are mounted from an impact load caused by a head-on collision of the vehicle, for instance, and support the batteries in a stable fashion. Also, this structure confers an advantage that areas of the engine room at the front of the front wheel houses can be used as part of the crush space which is critical in the event of a collision, making it possible to effectively improve the safety of vehicle occupants.

In another feature of the invention, the structure for arrangement of the engine-associated components of the aforementioned third principal form includes supporting brackets affixed to left and right suspension towers which are erected along the wheel houses for the front wheels, wherein the aforementioned at least two batteries are sustained by the supporting brackets.

In this structure, the supporting brackets for the batteries are affixed to the left and right suspension towers which are erected along the wheel houses for the front wheels, so that it is possible to effectively reinforce portions of the vehicle body where the suspension towers are erected by the supporting brackets and support the batteries by the supporting brackets in a stable fashion.

In another feature of the invention, the structure for arrangement of the engine-associated components of the aforementioned third principal form is such that each of the supporting brackets includes a bottom plate affixed to the suspension tower therealong, a side plate affixed to the bottom plate along one end thereof, and gusset plates affixed to the bottom plate along other ends thereof.

In this structure, it is possible to reinforce the portions of the vehicle body where the suspension towers are erected more effectively by the bottom plate, the side plate and the gusset plates which together constitute the supporting brackets. This confers an advantage that it is possible to sufficiently improve the stiffness of the portions of the vehicle body where the suspension towers are erected.

In another feature of the invention, the structure for arrangement of the engine-associated components of the aforementioned third principal form is such that the intake air passage is arranged to extend along a longitudinal direction of a vehicle body so that the intake air passage passes between the aforementioned at least two batteries which are disposed on the left and right sides of the engine body.

In this structure, it is possible to linearly arrange the intake air passage over a sufficient overall length such that the intake air passage passes between the aforementioned at least two batteries which are disposed on the left and right sides of the engine body. This makes it possible to effectively improve the air intake performance by use of intake air inertia.

In another feature of the invention, the structure for arrangement of the engine-associated components of the aforementioned third principal form includes at least two tower bars interconnecting left and right suspension towers which are erected along wheel houses for front wheels located at left and right sides of the engine room, the aforementioned at least two tower bars being arranged at a specific distance from one another in a longitudinal direction of a vehicle body, wherein the aforementioned at least two batteries together constituting the power supply system of the vehicle are located between the adjacent tower bars.

In this structure, the aforementioned at least two tower bars interconnecting the left and right suspension towers serve to effectively prevent the suspension towers from tipping over inward and sufficiently improve the stiffness of the vehicle body, and the batteries can be properly arranged by using a space formed between the aforementioned at least two tower bars. This structure is also advantageous in that the areas of the engine room at the front of the front wheel houses can be used as part of the crush space which is critical in the event of a collision.

In another feature of the invention, the structure for arrangement of the engine-associated components of the aforementioned third principal form is such that the aforementioned at least two batteries are symmetrically disposed on both sides of the engine body.

In this structure, the aforementioned at least two batteries are symmetrically disposed on both sides of the engine body, so that it is possible to properly balance the weight of the vehicle along the traverse direction of the vehicle body. This is advantageous in that the driving stability of the vehicle can be further improved in an effective fashion.

In another feature of the invention, the structure for arrangement of the engine-associated components of the aforementioned third principal form further includes a connecting member which interconnects the aforementioned at least two tower bars.

In this structure, the connecting member interconnecting the front and rear tower bars serves to reinforce the tower bars and increase the stiffness thereof. This is advantageous in that the tower bars can prevent the suspension towers from tipping over inward and protect the areas where the individual batteries are mounted from an impact load caused by a head-on collision of the vehicle, for instance, in a more effective fashion.

In still another feature of the invention, the structure for arrangement of the engine-associated components of the aforementioned third principal form further includes an air guide provided between the aforementioned at least two tower bars for guiding fresh air to areas where the batteries are disposed.

In this structure, the air guide guides the fresh air introduced through an opening formed in a front bumper or in a hood, for instance, to the areas where the batteries are mounted to cool the individual batteries. This structure is advantageous in that it is possible to effectively prevent deterioration of the batteries due to an excessive temperature increase thereof as well as deterioration of charging performance thereof.

In yet another feature of the invention, the structure for arrangement of the engine-associated components of the aforementioned third principal form is such that the intake air passage is arranged to extend along the longitudinal direction of the vehicle body so that the intake air passage passes between the aforementioned at least two batteries which are disposed on the left and right sides of the engine body.

In this structure, it is possible to linearly arrange the intake air passage over a sufficient overall length such that the intake air passage passes between the aforementioned at least two batteries which are disposed on the left and right sides of the engine body. This makes it possible to effectively improve the air intake performance by use of intake air inertia.

This application claims priority from Japanese Patent Application Serial Nos. 2005-100523, 2005-100524, and 2005-100525, all of which were filed in Japan Patent Office on Mar. 31, 2005, thus the entire contents of which are incorporated by reference. Stated other way, it is deemed that the contents of aforementioned applications constitute part of this application.

Although the present invention has been described in term of specific exemplary embodiments, it will be appreciated that various changes and modifications may be made by those skilled in the art without departing from the spirits and scope of the invention, defined in the following claims.

What is claimed is:

1. A structure for arrangement of engine-associated components including a main battery and a secondary battery which together constitute a power supply system of a vehicle in which a fresh air conduit is laid at a forward part of an engine room, an engine body is installed at a rear part of the engine room and fresh air drawn in through the fresh air conduit is supplied to the engine body through an intake air passage, wherein said main battery is disposed on one side of the engine body and said secondary battery is disposed on one side of said main battery.

2. The structure according to claim 1, wherein said main battery is disposed between a wheel house for one of front wheels located at one side of the engine room and a traversely extending dash panel mounted at a rear end of the engine room.

3. The structure according to claim 1, wherein said secondary battery is disposed between a wheel house for one of front wheels located at one side of the engine room and a traversely extending dash panel mounted at a rear end of the engine room.

4. A structure for arrangement of engine-associated components including a main battery and a secondary battery which together constitute a power supply system of a vehicle in which a fresh air conduit is laid at a forward part of an engine room and an engine body is installed at a rear part of the engine room, wherein said main battery is disposed on one side of the engine body and said secondary battery is disposed in a passenger compartment of the vehicle.

5. The structure according to claim 4, wherein said secondary battery is disposed below a traversely extending dash panel mounted at a rear end of the engine room.

6. The structure according to claim 4, wherein said secondary battery is disposed underneath a seat cushion of an occupant seat installed in the passenger compartment.

7. A structure for arrangement of engine-associated components including at least two batteries which together constitute a power supply system of a vehicle in which a fresh air conduit is laid at a forward part of an engine room, an engine body is installed at a rear part of the engine room and fresh air drawn in through the fresh air conduit is supplied to the engine body through an intake air passage, wherein said at least two batteries are disposed on left and right sides of the engine body.

8. The structure according to claim 7, wherein said at least two batteries are symmetrically disposed on both sides of the engine body.

9. The structure according to claim 7, wherein said at least two batteries are disposed in areas surrounded by wheel houses for front wheels located at left and right sides of the engine room and the engine body.

10. The structure according to claim 9, said structure comprising supporting brackets affixed to left and right suspension towers which are erected along the wheel houses for the front wheels, wherein said at least two batteries are sustained by said supporting brackets.

11. The structure according to claim 10, wherein each of said supporting brackets includes a bottom plate affixed to said suspension tower therealong, a side plate affixed to the bottom plate along one end thereof, and gusset plates affixed to the bottom plate along other ends thereof.

12. The structure according to claim 7, wherein said intake air passage is arranged to extend along a longitudinal direction of a vehicle body so that said intake air passage passes between said at least two batteries which are disposed on the left and right sides of the engine body.

13. The structure according to claim 7, said structure comprising at least two tower bars interconnecting left and right suspension towers which are erected along wheel houses for front wheels located at left and right sides of the engine room, said at least two tower bars being arranged at a specific distance from one another in a longitudinal direction of a vehicle body, wherein said at least two batteries together constituting the power supply system of the vehicle are located between said adjacent tower bars.

14. The structure according to claim 13, wherein said at least two batteries are symmetrically disposed on both sides of the engine body.

15. The structure according to claim 13, said structure further comprising a connecting member which interconnects said at least two tower bars.

16. The structure according to claim 13, said structure further comprising an air guide provided between said at least two tower bars for guiding fresh air to areas where said batteries are disposed.

17. The structure according to claim 13, wherein said intake air passage is arranged to extend along the longitudinal direction of the vehicle body so that said intake air passage passes between said at least two batteries which are disposed on the left and right sides of the engine body.
